(19) United States
(12) Patent Application Publication
(10) Pub. No.: US 2024/0272111 A1
(43) Pub. Date: Aug. 15, 2024

(54) ELECTROCHEMICAL GAS SENSOR

(71) Applicant: Dräger Safety AG & Co. KGaA, Lübeck (DE)

(72) Inventors: Steffen RITTEMANN, Lübeck (DE); Beate RITZ, Lübeck (DE); Helge GOTZEL, Lübeck (DE); Anja ALBRECHT, Lübeck (DE); Tanja SCHWARZ, Lübeck (DE)

(21) Appl. No.: 18/436,131

(22) Filed: Feb. 8, 2024

(30) Foreign Application Priority Data
Feb. 15, 2023 (DE) 10 2023 103 639.4

(51) Int. Cl. G01N 27/30; G01N 27/407

(52) U.S. Cl. CPC G01N 27/301; G01N 27/4075; G01N 27/4078

(57) ABSTRACT

An electrochemical gas sensor is provided. The electrochemical gas sensor has a housing divided in a transverse direction by a partition extending in a height direction of the housing into a housing inner area and a housing outer area, a measuring electrode, a reference electrode, and a hydrophilic membrane. The measuring electrode and the hydrophilic membrane are disposed in the housing inner area. The hydrophilic membrane has a membrane arm for receiving the reference electrode. The membrane arm extends from the housing inner area into the housing outer area so that the reference electrode is disposed in the housing outer area.

### CROSS REFERENCE TO RELATED APPLICATIONS

This application claims the benefit of priority under 35 U.S.C. § 119 of German Application 10 2023 103 639.4, filed Feb. 15, 2023, the entire contents of which are incorporated herein by reference.

### TECHNICAL FIELD

The present invention pertains to an electrochemical gas sensor.

### BACKGROUND

Electrochemical gas sensors are known. Electrochemical gas sensors have a measuring electrode at which a reaction of a target gas contained in a sample gas occurs, i.e., a reaction with the target gas. This reaction leads to measurable electrical quantities, from which statements can be made about the target gas.

Providing an electrochemical gas sensor in a compact manner is advantageous for many technical applications. For this purpose, it is known to use a stack arrangement of electrodes and membrane layers, with the electrodes being connected via electrolytes enclosed in the membrane layers.

The disadvantage of such electrochemical gas sensors is that they are sensitive to target gas entering the stack arrangement, as this can lead to falsifications in the measurement result.

### SUMMARY

It is an object of the invention to provide an electrochemical gas sensor having an improved measurement behavior.

This and further objects are attained by the subject matter of this disclosure.

Various advantageous embodiments are provided by this disclosure.

According to the invention, an electrochemical gas sensor is provided in this respect. The electrochemical gas sensor has a housing, which is divided in the transverse direction into a housing inner area and a housing outer area by a partition extending in a height direction of the housing, a measuring electrode, a reference electrode and a hydrophilic membrane. The measuring electrode and the hydrophilic membrane are disposed in the inner area of the housing. The hydrophilic membrane has a membrane arm to accommodate the reference electrode. The membrane arm extends from the housing inner area into the housing outer area, so that the reference electrode is disposed in the housing outer area.

The provided electrochemical gas sensor solves the task according to the invention in that the reference electrode is arranged in the housing outer area, while the measuring electrode is arranged in the housing inner area. This local separation of reference electrode and measuring electrode ensures that the reference electrode does not come into contact, or only comes into contact to a small extent, with a target gas that reaches the measuring electrode. The reference electrode can thus provide a reference potential that is as constant as possible and thus act as a particularly reliable reference when measuring the target gas.

An electrochemical gas sensor is understood to be an electrochemical cell that is set up to detect at least one gaseous substance (in particular a target gas) in a gas or gas mixture (in particular in a sample gas).

In a preferred case, the electrochemical gas sensor is configured as an oxygen sensor that is set up to detect oxygen in a gas or gas mixture.

In the following, the terms “electrochemical gas sensor” and “gas sensor” are used interchangeably.

The height direction of the housing is understood to be an extension direction of the housing, i.e., a direction extending perpendicular to a base surface of the housing.

By transverse direction, it is meant a direction perpendicular to the height direction of the housing, that is, a direction parallel to a base surface of the housing.

A membrane arm of the hydrophilic membrane is understood to mean a part of the hydrophilic membrane that projects laterally (with respect to a normal direction of the hydrophilic membrane) and is configured to accommodate the reference electrode and protrude into the outer area of the housing. The hydrophilic membrane together with the membrane arm preferably extends essentially in a plane, so that a substantially planar hydrophilic membrane is provided.

The hydrophilic membrane is configured to receive an aqueous electrolyte, for example an aqueous solution comprising sulfuric acid, and to be in communication with the measuring electrode as well as with the reference electrode, so that by means of the hydrophilic membrane and the electrolyte received therein a connection between the reference electrode and the measuring electrode is achieved. The measuring electrode is preferably arranged at or on the hydrophilic membrane or is in connection with the hydrophilic membrane via further membranes, so that the gas sensor is provided in a stacked configuration.

The partition may or may not be of continuous construction, for example the partition may have one or more separate segments for this purpose. The partition wall may be annular in a top view. The partition wall may extend from a bottom surface of the housing and preferably be integrally formed with the housing. It is preferred that the housing and the partition are made of a gas impermeable material.

Preferably, the electrochemical gas sensor has a gas inlet in a bottom surface thereof for conducting sample gas from the environment of the gas sensor towards the measuring electrode. Further preferably, the gas inlet is arranged to conduct sample gas into the interior of the housing. Preferably, the measuring electrode is arranged between the hydrophilic membrane and the gas inlet to convert target gas contained in the entering sample gas.

The housing outer area may be arranged for storing the electrolyte. In this respect, it is known that an electrolyte in an electrochemical gas sensor can absorb and release water by changing the ambient humidity of the electrochemical gas sensor, and thus a volume of the electrolyte inside the gas sensor is variable. As a result of the volume expansion, the electrolyte can escape into the housing outer area and be available there as a supply. According to the invention, the housing outer area and the housing inner area are in fluid-conducting communication via the membrane arm in order to conduct excess electrolyte from the hydrophilic membrane into the housing outer area and vice versa. In other words, the membrane arm forms a kind of wick. In this respect, the housing outer area may be trough-like, bounded by a bottom surface of the housing, a side wall of the housing, and by the partition.

Preferably, the hydrophilic membrane, preferably the membrane arm of the hydrophilic membrane, is in contact with the partition wall in such a way that gas passage from the gas inlet in the direction of the housing outer area and in particular in the direction of the reference electrode and vice versa is prevented. This can be achieved, for example, by flush arrangement of the hydrophilic membrane and membrane arm on or against the partition so that there is essentially no gap between the hydrophilic membrane or its membrane arm and the partition.

Particularly preferably, however, the partition wall has a recess, the recess being arranged to be in gas-tight engagement with the membrane arm.

In this way, the membrane arm can be passed through (guided through) the recess from the inner area of the housing to project into the outside area of the housing and a gas-tight installation of the membrane arm with the recess can be achieved in a simple manner. Thus, a gas passage along an abutment surface between the membrane arm and the partition wall can be prevented in an advantageous manner by this gas-tight system.

Particularly preferably, the recess is configured in such a way that it occupies a predetermined distance from a bottom surface of the housing outer area. For this purpose, the recess can have, for example, an abutment surface which can have the predetermined distance from the bottom surface of the housing outer area.

The provision of the predetermined distance has the effect that the membrane arm does not rest flush on the bottom surface when in contact with the recess or with the abutment surface. This minimizes the risk of the membrane arm wrinkling during installation or operation, for example due to changes in the position of the gas sensor, which could lead to gas leakage. The gas sealing effect can thus be advantageously improved compared to an embodiment in which the membrane arm rests flush on a bottom surface of the outer area of the housing or of the housing.

Preferably, the gas sensor further comprises a hold-down device, wherein the hold-down device is arranged to hold the membrane arm in gas-tight contact with the recess, preferably with the abutment surface of the recess, if present.

By means of the hold-down device, degrees of freedom in the movement of the membrane arm relative to the recess or the abutment surface can be restricted, so that the gas-tight effect can be improved. Furthermore, the hold-down device can press the membrane arm against or onto the abutment surface with predetermined contact pressure, which can further improve the gas sealing effect of the membrane arm.

In a preferred embodiment, the hold-down device may further be arranged to hold further parts of the hydrophilic membrane in gas-tight, for example flush, contact with the partition wall in addition to the membrane arm. Thus, the further parts of the hydrophilic membrane can be pressed by the hold-down device with predetermined contact pressure against or onto the abutment surface, whereby the gas sealing effect can be further improved.

The hold-down device may be provided as an independent component of the gas sensor.

In a preferred embodiment of the invention, the housing is configured in two parts and includes a bottom element and a cover element, wherein the bottom element and cover element are connectable to form the housing. For example, the bottom element and the cover element may be connectable by means of a snap-fit connection.

In this preferred embodiment, it is further preferred that the hold-down element is integrally formed with the cover element. For example, the hold-down element may be provided as a protrusion or a plurality of protrusions in the form of one or more hold-down elements in the cover element and may be brought into abutment with the membrane arm and, optionally, other parts of the hydrophilic membrane by or when the cover element is connected to the base element.

Preferably, the gas sensor further comprises a counter electrode. In this case, the measuring electrode, reference electrode and counter electrode are connected via the electrolyte.

Preferably, the gas sensor comprises a pressure equalization opening (pressure equalization port or pressure equalization orifice) in an upper side, wherein the gas sensor further comprises a protective electrode, and wherein the protective electrode is arranged between the pressure equalization opening and the measuring electrode.

In this respect, a protective electrode is understood to be an electrode which is set up to react with an undesired substance, in particular to react with the target gas or an undesired gas (interfering gas), so that any target gas or interfering gas which may enter the gas sensor in an undesired manner can be converted before striking the measuring electrode. Such a case can exist in particular if a pressure equalization opening is provided, because target gas or interfering gas can possibly enter through this opening.

By providing the pressure equalization opening, an interior of the gas sensor is arranged for pressure equalization with the environment, whereby the measurement behavior of the gas sensor can be improved.

By arranging the protective electrode between the pressure equalization opening and the measuring electrode, the protective electrode can convert any target gas entering through the pressure equalization opening before it can reach the reference electrode or the measuring electrode and thus falsify the measurement. It is particularly advantageous if a surface of the protective electrode is larger than a surface of the measuring electrode. This also offers the advantage that a potential drop at the protective electrode is small compared to a protective electrode with a smaller surface, so that the measurement behavior can be further improved.

Preferably, the pressure equalization opening and the gas inlet, if any, are located in opposite sides of the housing.

Preferably, the counter electrode and/or the protective electrode is arranged on another hydrophilic membrane.

Particularly preferably, the counter electrode and/or the protective electrode is arranged on a further hydrophilic membrane comprising a further membrane arm, wherein the further membrane arm and the membrane arm overlap.

Overlapping in this context refers to an arrangement of the membrane arm and the further membrane arm in such a way that they at least overlap, preferably coincide, in a projection along the height direction of the housing (i.e., in a top view).

In this way, the reference electrode is accommodated between the membrane arm and the further membrane arm, which advantageously leads to redundancy in the structure of the gas sensor. This means that any damage to either the membrane arm or the further membrane arm that may occur during assembly or operation of the gas sensor can be compensated for. This is achieved by the other further membrane arm or membrane arm continuing to be connected to the reference electrode, so that this consequently continues to be in communication with the measuring electrode, the counter electrode and the protective electrode, if present, via the electrolyte received (absorbed) in the hydrophilic membrane or further hydrophilic membrane. Damage during an operation of the sensor may occur, for example, due to shocks or due to vibrations.

Furthermore, even in a normal operating state, this ensures that the reference electrode is in contact with electrolyte on both sides via the membrane arm and via the further membrane arm.

As the reference electrode is surrounded by the membrane arm and by the further membrane arm, the reference electrode is also better protected against mechanical damage.

Further preferably, in this arrangement, the further hydrophilic membrane is disposed between the protective electrode, if present, and the pressure equalization orifice, with the measurement electrode disposed between the hydrophilic membrane and the gas inlet, if present.

Preferably, the hydrophilic membrane and/or the further hydrophilic membrane comprises a fibrous material, in particular a nonwoven fibrous material.

Particularly preferably, the hydrophilic membrane and/or the further hydrophilic membrane comprises a fiber material, in particular a nonwoven fiber material.

The use of a fiber material advantageously reduces the manufacturing costs of the gas sensor.

Preferably, the fiber material is formed as a glass fiber material, in particular as a glass nonwoven. Preferably, the fiber material is a nonwoven glass microfiber fabric, in particular a nonwoven borosilicate glass microfiber fabric. Glass nonwoven fabric or glass microfiber nonwoven fabric has a sufficiently high hydrophilicity due to its microporosity, without the need for further treatment such as a surface coating of the material. Therefore, another advantage in using fiber materials is that they retain their hydrophilicity throughout the life of the gas sensor. This is not the case with other classes of materials, particularly hydrophilized PTFE-based membranes. In the context of the invention, it was recognized that the latter can lose their hydrophilicity after about 1.5 years, rendering the gas sensor unusable.

Particularly preferably, the hydrophilic membrane and/or the further hydrophilic membrane does not comprise PTFE in this respect.

Another advantage of using fiber material over other materials is that the fiber material is more malleable than, for example, sintered materials, so that the fiber material conforms particularly well to the partition or recess or abutment surface.

Preferably, the hydrophilic membrane has a plurality of membrane arms, each of the plurality of membrane arms extending from the housing inner region into the housing outer region.

In this manner, the positional independence of the gas sensor can be increased. In this respect, each of the plurality of membrane arms acts as a fluid-conducting connection between the housing outer area and the housing inner area in the manner described above. Thus, even if the gas sensor is oriented at an angle, it can be ensured that liquid, i.e., electrolyte, can be conducted via at least one of the plurality of membrane arms.

Preferably, the hydrophilic membrane has as a plurality of membrane arms at least three, more preferably at least four membrane arms.

Preferably, the reference electrode is integrally formed with the membrane arm.

Thus, it can be easily achieved that the reference electrode is stationary relative to the hydrophilic membrane, so that the reference electrode cannot slip during an assembly and during operation.

For example, the reference electrode can be printed onto the hydrophilic membrane to provide the integral formation.

Preferably, the gas sensor has a gas inlet in a lower side, wherein the gas sensor has an electrolyte-tight membrane, in particular a hydrophobic membrane, which is arranged between the measuring electrode and the gas inlet.

In this way, electrolyte can advantageously be prevented from escaping through the gas inlet. In this case, the electrolyte-tight membrane is gas-permeable, so that gas entry through the gas inlet is possible.

Preferably, the electrolyte-tight membrane has a thickness of not more than 10 μm.

It has been recognized in the context of the invention that such a thickness contributes to a sufficiently fast measurement, so that the gas sensor is particularly suitable for use in, for example, respiratory devices such as ventilators and anesthesia machines.

The electrolyte-tight membrane can be configured, for example, as a PTFE membrane.

An electrolyte-tight and gas-permeable membrane with comparable advantages can also be arranged between the pressure equalization opening and the counter-electrode, if present.

The gas sensor can have a filter in front of or behind the pressure equalization opening. Supplementally or alternatively, the gas sensor may comprise a filter upstream or downstream of the gas inlet.

These and further features and advantages of the invention are also apparent from the description of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic sectional view of an embodiment of a gas sensor according to the invention;

FIG. 2 is a schematic sectional view of an embodiment example of a gas sensor according to the invention;

FIG. 3 is a schematic sectional view of an embodiment example of a gas sensor according to the invention;

FIG. 4 is a schematic sectional view of an embodiment example of a gas sensor according to the invention;

FIG. 5a is a schematic top view of an embodiment example of a further hydrophilic membrane according to the invention;

FIG. 5b is a schematic top view of an embodiment example of a further hydrophilic membrane according to the invention with a protective electrode;

FIG. 6a is a schematic top view of an embodiment example of a hydrophilic membrane according to the invention;

FIG. 6b is a schematic top view of an embodiment example of a hydrophilic membrane according to the invention with reference electrode;

FIG. 7 is a schematic top view of an embodiment example of a bottom part according to the invention; and

FIG. 8 is a perspective view of an embodiment example of a bottom part according to the invention.

### DESCRIPTION OF PREFERRED EMBODIMENTS

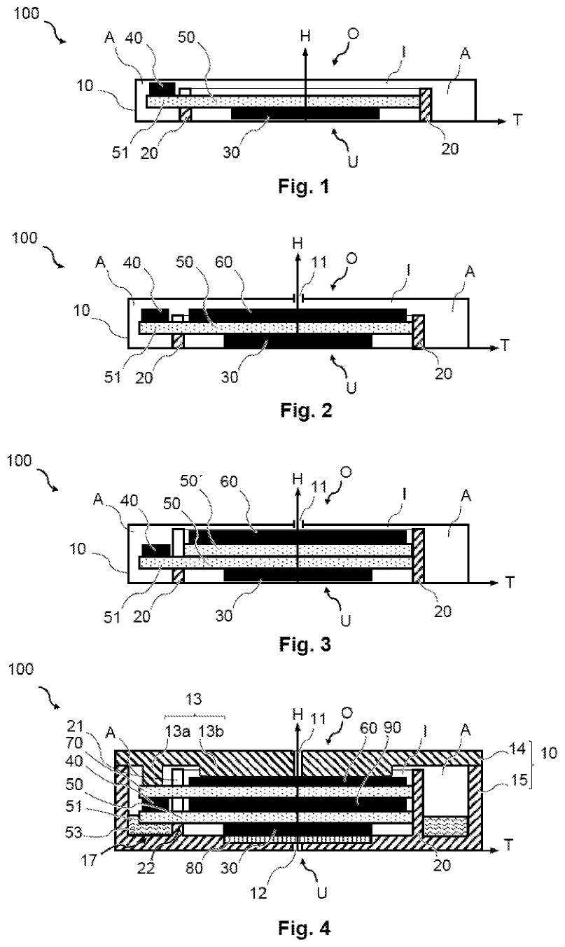

Referring to the drawings, according to the invention, an electrochemical gas sensor 100 is provided. Examples of electrochemical gas sensors 100 are shown in FIGS. 1 to 4.

The electrochemical gas sensor 100 has a housing 10, which is only schematically indicated in FIGS. 1 to 3. In one embodiment, the housing 10 may be of a two-part configuration and comprise a bottom element 15 and a cover element 14, which may be assembled to form the housing 10. Such a two-part housing is shown schematically in FIG. 4.

As shown in FIGS. 1-4, 7 and 8, the housing 10 is divided in the transverse direction T into an inner housing area I and an outer housing area A by a partition 20 extending in a height direction H of the housing 10. The partition 20 may, for example, extend from a bottom surface 17 of the housing 10 and preferably be integrally formed with the housing 10.

The electrochemical gas sensor 100 further comprises a sensing electrode 30, a reference electrode 40, and a hydrophilic membrane 50, as shown in FIGS. 1-4. In all embodiments, as is also shown, the electrochemical gas sensor 100 may further comprise a counter electrode 60. As further shown, the sensing electrode 30 and the hydrophilic membrane 50, and preferably further the counter electrode 60, are arranged in the housing interior I where they form a stacked arrangement.

The hydrophilic membrane 50 has a membrane arm 51 for receiving the reference electrode 40, as indicated in FIGS. 1-4 and shown in FIGS. 6a, 6b. In FIGS. 6a, 6b, it is shown that the hydrophilic membrane 50 may have, for example, a membrane body 52, which may correspond in shape to, for example, a partition wall inner surface and may be, for example, substantially circular. The membrane arm 51 may extend from the membrane body 52.

In FIGS. 1-4, it can be seen that the housing outer area A can be formed in a trough-like manner to accommodate an electrolyte, indicated in FIG. 4 as electrolyte 53. The housing outer area A can be bounded on the bottom side, for example, by the bottom surface 17, the partition 20 and an outer side of the bottom element 15, as this is shown in FIG. 4. In the embodiments shown, the housing outer area A is thus set up for storing the electrolyte 53, with the membrane arm 51 forming a kind of wick in the manner described above.

Preferably, and shown in FIGS. 6a, 6b, the hydrophilic membrane 50 may have a plurality of membrane arms 51, 51a, 51b, 51c, each of the plurality of membrane arms 51, 51a, 51b, 51c projecting from the housing inner area I into the housing outer area A. In this regard, one of the membrane arms 51 receives the reference electrode 40. The plurality of membrane arms 51, 51a, 51b, 51c may be configured in the same way, as is the case in the example shown, or may be formed in different ways.

Preferably, the reference electrode 40 is integrally formed with the membrane arm 51, as can be seen in FIG. 6b. For example, the reference electrode 40 may be printed on the hydrophilic membrane 50 to provide the integral formation.

The membrane arm 51 extends from the housing inner area I into the housing outer area A, so that the reference electrode 40 is arranged in the housing outer area A, as can be seen in FIGS. 1-4 and 7.

In a preferred embodiment of the invention illustrated in FIGS. 4, 7 and 8, the housing 10 may be configured in two parts in that the housing 10 comprises a bottom element 15 and a cover element 14, wherein the bottom element 15 and the cover element 14 are connectable. In this regard, the bottom element 15 preferably provides the bottom surface 17 from which the partition 20 extends.

Preferably, the electrochemical gas sensor 100 has a gas inlet 12 in a bottom side U for guiding the sample gas from the environment of the gas sensor 100 towards the measuring electrode 30, as schematically shown in FIG. 4. As shown, it is preferred that the gas inlet 12 is arranged to conduct the sample gas into the housing interior I. For this purpose, the gas inlet 12 can, for example, be arranged centrally in the bottom side U. Preferably, the measuring electrode 30 is arranged between the hydrophilic membrane 50 and the gas inlet 12 as shown.

Preferably and as shown in FIGS. 1 to 4, the hydrophilic membrane 50 and the membrane arm 51 are in contact with the partition 20 in such a way that gas passage from the gas inlet 12 in the direction of the housing outer area A and in particular in the direction of the reference electrode 40 and vice versa is prevented.

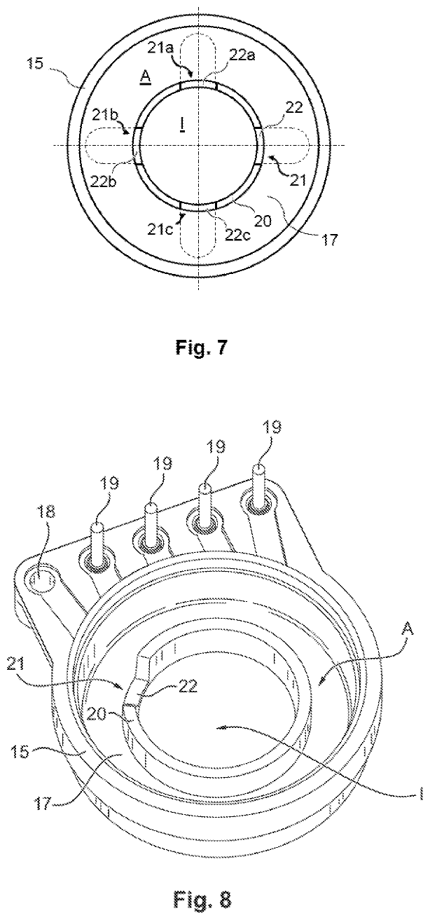

Preferably and indicated in FIGS. 1-4 and shown in FIGS. 7 and 8, the partition 20 has a recess 21, which can have, for example, an abutment surface 22, the recess 21, preferably the abutment surface 22, being arranged to be in gas-tight abutment with the membrane arm 51.

In the variant shown in FIG. 8, the partition 20 has only exactly one recess 21 with an abutment surface 22 corresponding to the membrane arm 51. In the variant shown in FIG. 7, the partition 20 has a plurality of recesses 21, 21a, 21b, 21c, for example as shown four recesses 21, 21a, 21b, 21c, each of which may have an abutment surface 22, 22a, 22b, 22c.

In the case where the partition 20 has a plurality of recesses 21, 21a, 21b, 21c, these correspond to the plurality of membrane arms 51, 51a, 51b, 51c.

As can be seen in FIG. 8, it is preferred that the recess 21 is configured in such a way that it occupies a predetermined distance from the bottom surface 17 of the housing outer area A, for example with respect to its abutment surface 22, so that the membrane arm 51 does not rest flush on the bottom surface 17.

The gas sensor 100 may comprise at least one additional hydrophilic membrane 50′. In the embodiment example according to FIG. 3, an additional hydrophilic membrane 50′ is in this respect arranged between the counter electrode 60 and the hydrophilic membrane 50. This allows a vertical distance (i.e., a distance in the height direction H) of the counter electrode 60 relative to the hydrophilic membrane 50, and thus relative to the reference electrode 40, to be selectively adjusted. Thus, the stack structure of the gas sensor 100 can be provided with higher degree of freedom.

Preferably, as shown in FIG. 4, the gas sensor 100 further comprises a hold-down device 13, wherein the hold-down device 13 is configured to hold the membrane arm 51 in gas-tight contact with the abutment surface 22.

It is preferred that the hold-down device 13 is integrally formed with the cover element 14. For example, as shown, the hold-down device 13 may be provided as a protrusion or a plurality of protrusions, for example in the form of a first hold-down element 13a and a second hold-down element 13b. The hold-down device 13 may be arranged to hold the membrane arm 51 in gas-tight contact with the recess 21 on both sides of the partition 20 by means of the first hold-down element 13a and the second hold-down element 13b.

By means of the particularly preferred combination of recess 21 and hold-down device 13 shown in FIG. 4, the membrane arm 51 can be clamped in the recess 21, for example via its abutment surface 22, whereby the gas-tight effect between membrane arm 51 and recess 21 can be improved.

Preferably, and as shown in FIGS. 2-4, the gas sensor 100 has a pressure equalization opening 11 in an top side O thereof.

Further preferably and as shown in FIG. 4, the gas sensor 100 comprises a protective electrode 90, wherein the protective electrode 90 is arranged between the pressure equalization opening 11 and the measuring electrode 30.

Preferably, and as shown in FIG. 4, the pressure equalization opening 11 and the gas inlet 12 are each arranged on opposite sides, i.e., on top side 11 and bottom side U of the housing 10.

Preferably and as shown in FIG. 4, the counter electrode 60 and/or the protective electrode 90 is arranged on a further hydrophilic membrane 70 having a further membrane arm 71, the further membrane arm 71 and the membrane arm 51 preferably overlapping as shown in FIGS. 3 and 4.

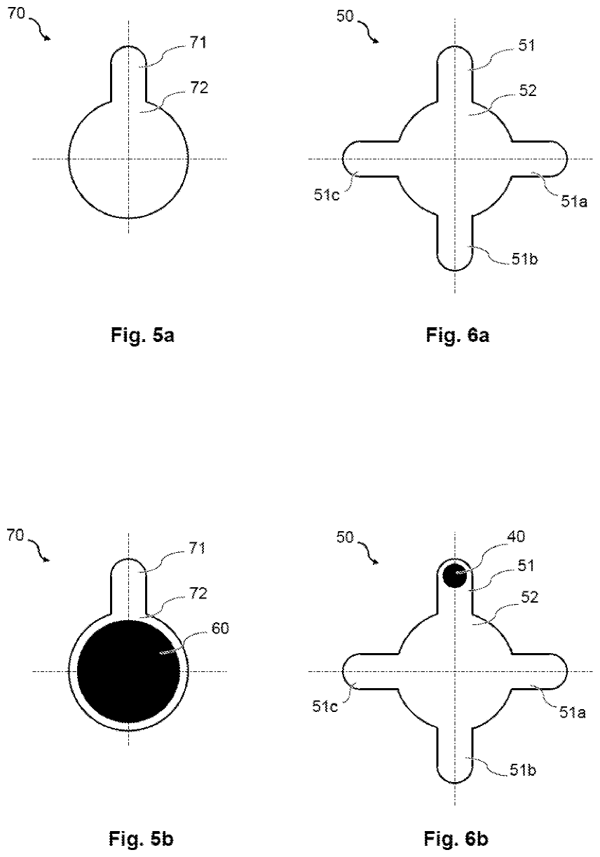

The further hydrophilic membrane 70 with the further membrane arm 71 is shown in FIG. 5a and with the counter electrode 60 arranged thereon in FIG. 5b. For example, the hydrophilic membrane 70 may have a partition wall inner side corresponding to, for example, a substantially circular further membrane body 72 from which the further membrane arm 71 extends.

As can be seen in FIG. 4, the reference electrode 40 may be received between the membrane arm 51 and the further membrane arm 71.

As can be seen in FIG. 4, the further hydrophilic membrane 70 may be disposed between the counter electrode 60 and the pressure equalizing orifice 11, and the measuring electrode 30 may be disposed between the hydrophilic membrane 50 and the gas inlet 12.

As can be seen in FIG. 4, the further hydrophilic membrane 70 may be arranged between the protective electrode 90 and the pressure equalization opening 11, wherein the measuring electrode 30 may be arranged between hydrophilic membrane 50 and gas inlet 12.

In the illustrated embodiments, the hydrophilic membrane 50 and/or the further hydrophilic membrane 70 comprises a fiber material, in particular a nonwoven fiber material.

Preferably, as shown in FIG. 4, the gas sensor 100 has the gas inlet 12 in its bottom side U, wherein the gas sensor 100 has an electrolyte-tight membrane 80 (in particular a hydrophobic membrane) arranged between the measuring electrode 30 and the gas inlet 12.

Preferably, in the illustrated example, the electrolyte-tight membrane 80 has a thickness of no more than 10 μm.

As shown in FIG. 8, the gas sensor 100 can have receiving openings 18 for contact pins 19 in an edge region of the bottom element 15, so that the gas sensor 100 can be integrated into a measuring system by means of the contact pins 19. The contact pins 19 can be in contact with the measuring electrode 30, reference electrode 40 and counter electrode 60 and protective electrode 90, if present, by means of metal wires not shown.

It is preferred in this case that one or more, preferably all, metal wires for contacting the aforementioned electrodes are not guided through the recess 21 into the interior of the housing I, but through one or more notches in the partition wall which differ locally from the recess 21. In particular, in the case that the housing is configured in two parts and the partition wall is arranged to be in flush abutment with an upper housing part, it is made possible in this way to guide the metal wire or wires through the one or more notches into the inner housing region I without reducing the gas sealing effect between the membrane arm 51 and the recess 21.

The gas sensor 100 may include additional electrodes. For example, the gas sensor 100 may have a further sensing electrode at which a further target gas may be converted (reacted).

All features disclosed herein may be combined with each other as desired, provided that this is not contradictory or relates to alternatives.

While specific embodiments of the invention have been shown and described in detail to illustrate the application of the principles of the invention, it will be understood that the invention may be embodied otherwise without departing from such principles.

### LIST OF REFERENCE CHARACTERS

10 Housing
11 Pressure equalization opening
12 Gas inlet
13 Hold-down device
13a, 13b Hold-down element
14 Cover element
15 Bottom element
17 Bottom surface
18 Receiving opening
19 Contact pin
20 Partition wall
21, 21a, 21b, 21c Recess
22, 22a, 22b, 22c Abutment surface
30 Measuring electrode
40 Reference electrode
50 Hydrophilic membrane
50′ Additional hydrophilic membrane
51, 51a, 51b, 51c Membrane arm
52 Membrane body
53 Electrolyte
60 Counter electrode
70 Additional hydrophilic membrane
71 Further membrane arm
72 Further membrane body
80 Electrolyte-tight membrane
90 Protective electrode
100 Gas sensor
A Housing outer area
H Height direction
I Inner housing area
O Top side
T Transverse direction
U Bottom side

What is claimed is:

1. An electrochemical gas sensor comprising:
a housing with a partition comprising a partition wall dividing the housing, into an inner housing area and an outer housing area, in a transverse direction extending in a height direction of the housing;
a measuring electrode;
a reference electrode; and
a hydrophilic membrane comprising a membrane arm for receiving the reference electrode,
wherein the measuring electrode and the hydrophilic membrane are arranged in the housing inner area, and
wherein the membrane arm projects from the housing inner area into the housing outer area such that the reference electrode is disposed in the housing outer area.

2. An electrochemical gas sensor according to claim 1, wherein the partition comprises a recess, said recess being adapted to be in gas-tight engagement with said membrane arm.

3. An electrochemical gas sensor according to claim 1, further comprising a hold-down device, wherein the hold-down device is configured to maintain the membrane arm in gas-tight engagement with the recess.

4. An electrochemical gas sensor according to claim 1, further comprising a protective electrode,
wherein the gas sensor has a pressure equalization opening in an upper surface, and
wherein the protective electrode is disposed between the pressure equalization opening and the measuring electrode.

5. An electrochemical gas sensor according to claim 4, further comprising:
a counter electrode; and
a further hydrophilic membrane comprising a further membrane arm,
wherein the counter electrode and/or the protective electrode is arranged on the further membrane arm, and
wherein the further membrane arm and the membrane arm overlap.

6. An electrochemical gas sensor according to claim 1, further comprising
a counter electrode; and
a further hydrophilic membrane comprising a further membrane arm,
wherein the counter electrode is arranged on the further membrane arm, and
wherein the further membrane arm and the membrane arm overlap.

7. An electrochemical gas sensor according to claim 6, wherein the hydrophilic membrane and/or the further hydrophilic membrane comprises a fiber material.

8. An electrochemical gas sensor according to claim 1, wherein the hydrophilic membrane comprises a fiber material.

9. An electrochemical gas sensor according to claim 1, wherein the hydrophilic membrane further comprises an additional membrane arm to provide a plurality of membrane arms, wherein each of the plurality of membrane arms projects from the housing inner area into the housing outer area.

10. An electrochemical gas sensor according to claim 1, wherein the reference electrode is integrally formed with the membrane arm.

11. An electrochemical gas sensor according to claim 1, further comprising an electrolyte-tight membrane,
wherein a gas inlet is provided in a bottom side,
wherein the electrolyte-tight membrane is arranged between the measuring electrode and the gas inlet.

12. An electrochemical gas sensor according to claim 11, wherein the electrolyte-tight membrane has a thickness of not more than 10 μm.

13. An electrochemical gas sensor according to claim 11, wherein the electrolyte-tight membrane is a hydrophobic membrane.
